(19) United States
(12) Patent Application Publication
(10) Pub. No.: US 2026/0275485 A1
(43) Pub. Date: Sep. 17, 2026

(54) Powder Supply System

(71) Applicant: TATSUTA ELECTRIC WIRE & CABLE CO., LTD., Osaka (JP)

(72) Inventor: Masaki HIRANO, Kizugawa-shi, Kyoto (JP)

(21) Appl. No.: 19/168,358

(22) PCT Filed: Mar. 7, 2024
(86) PCT No.: PCT/JP2024/008658

§ 371 Date: Sep. 24, 2025

(30) Foreign Application Priority Data
Mar. 27, 2023 (JP) 2023-050026

(51) Int. Cl. C23C 4/12; B65D 88/26

(52) U.S. Cl. CPC C23C 4/12; B65D 88/26

(57) ABSTRACT

The powder supply system includes a hopper, a powder supply unit, a pressure adjustment unit, and an on-off valve. The hopper stores powder to be supplied to a film deposition apparatus. The powder supply unit is connected to the hopper, and supplies the powder to the hopper while maintaining a constant pressure difference with respect to the hopper. The pressure adjustment unit that adjusts an internal pressure of the hopper and an internal pressure of the powder supply unit so as to maintain the internal pressure of the hopper and the internal pressure of the powder supply unit constant. The on-off valve is provided on a member that connects the hopper and the powder supply unit.

### TECHNICAL FIELD

The present disclosure relates to a powder supply system.

### BACKGROUND ART

For example, Japanese Patent Laying-Open No. 2007-75814 (PTL 1) discloses a powder supply system which is used in thermal spraying and is configured to supply powder to a storage container without interrupting the operation of a powder supply unit.

### CITATION LIST

### Patent Literature

PTL 1: Japanese Patent Laying-Open No. 2007-75814

### SUMMARY OF INVENTION

### Technical Problem

According to the powder supply system disclosed in Japanese Patent Laying-Open No. 2007-75814, it is required to constantly store a minimum amount of powder in the storage container. Thus, the powder can be continuously supplied to the object. However, if the powder is continuously supplied to the object, the amount of powder to be supplied may change over time.

In order to stabilize the amount and quality of powder to be supplied without changing over time, it is preferable to use a gas to maintain an internal pressure of the storage container constant, for example. During thermal spraying, it is difficult to supply the powder from the outside of the powder supply system. Japanese Patent Laying-Open No. 2007-75814 does not consider supplying powder from the outside of the storage container and the internal pressure of the storage container.

The present disclosure has been made in view of the abovementioned problems. An object of the present disclosure is to provide a powder supply system capable of supplying powder continuously and stably over time.

### Solution to Problem

A powder supply system according to the present disclosure includes a hopper, a powder supply unit, a pressure adjustment unit, and an on-off valve. The hopper that stores powder to be supplied to a film deposition apparatus. The powder supply unit is connected to the hopper, and supplies the powder to the hopper while maintaining a constant pressure difference with respect to the hopper. The pressure adjustment unit adjusts an internal pressure of the hopper and an internal pressure of the powder supply unit so as to maintain the internal pressure of the hopper and the internal pressure of the powder supply unit constant. The on-off valve is provided on a member that connects the hopper and the powder supply unit.

### Advantageous Effects of Invention

According to the present disclosure, it is possible to provide a powder supply system capable of supplying powder continuously and stably over time.

### BRIEF DESCRIPTION OF DRAWINGS

FIG. 1 is a schematic diagram illustrating a configuration of a film deposition apparatus according to the present embodiment.

FIG. 2 is a schematic diagram illustrating a configuration of a powder supply system according to the present embodiment.

FIG. 3 is a schematic diagram illustrating a powder refill unit and a powder container.

FIG. 4 is a table listing a series of steps for supplying powder and refilling powder in the powder supply system according to the present embodiment, and states of respective constituent members.

### DESCRIPTION OF EMBODIMENTS

Hereinafter, an embodiment of the present disclosure will be described. The same components will be denoted by the same reference numerals, and the description thereof will not be repeated.

### Configuration of Film Deposition Apparatus

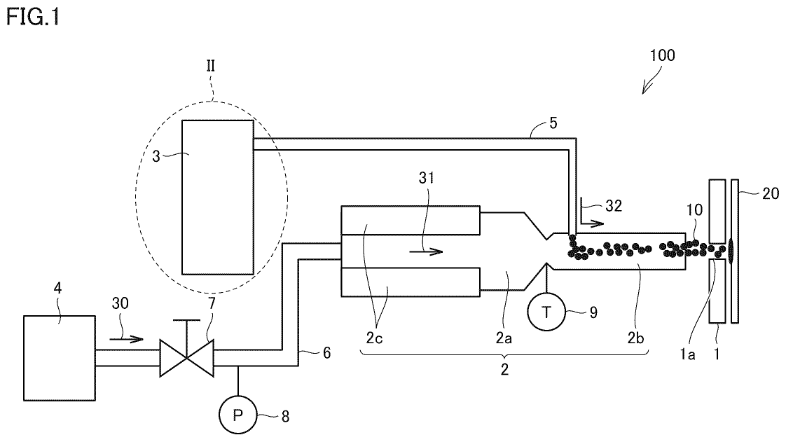

FIG. 1 is a schematic diagram illustrating a film deposition apparatus according to the present embodiment. With reference to FIG. 1, a film deposition apparatus 100 mainly includes a spray gun 2 provided with a nozzle 2b, a powder feed unit 3, a gas supply unit 4, and a mask jig 1.

The spray gun 2 mainly includes a spray gun main body 2a, a nozzle 2b, a heater 2c, and a temperature sensor 9. The nozzle 2b is connected to a first end, i.e., a front end of the spray gun main body 2a. A pipe 6 is connected to a second end, i.e., a rear end of the spray gun main body 2a. The pipe 6 is connected to the gas supply unit 4 via a valve 7. The gas supply unit 4 supplies a working gas to the spray gun 2 via the pipe 6. The supply of the working gas from the gas supply unit 4 to the spray gun 2 can be controlled by opening and closing the valve 7. The pipe 6 is installed with a pressure sensor 8. The pressure sensor 8 measures the pressure of the working gas supplied from the gas supply unit 4 to the pipe 6.

The working gas supplied from the second end of the spray gun main body 2a into the spray gun main body 2a is heated by the heater 2c. The heater 2c is disposed on the side of the second end of the spray gun main body 2a. The working gas flows through the spray gun main body 2a in a direction indicated by an arrow 31. The temperature sensor 9 is connected to a connection portion between the nozzle 2b and the spray gun main body 2a. The temperature sensor 9 measures the temperature of the working gas flowing through the spray gun main body 2a.

A pipe 5 is connected to the nozzle 2b. The pipe 5 is also connected to the powder feed unit 3. The powder feed unit 3 supplies powder to the nozzle 2b of the spray gun 2 via the pipe 5 as a film deposition raw material.

The mask jig 1 is disposed between a substrate 20 and the spray gun 2. The mask jig 1 is formed with a through hole la. The through hole la defines a film deposition region on a surface of the substrate 20.

### Operation of Film Deposition Apparatus

In the film deposition apparatus 100 illustrated in FIG. 1, as indicated by an arrow 30, the working gas is supplied from the gas supply unit 4 to the spray gun 2 via the pipe 6. The working gas may be, for example, nitrogen, helium, dry air, or a mixture thereof. The pressure of the working gas is, for example, about 1 MPa. The flow rate of the working gas is, for example, 300 L/min or more and 500 L/min or less. The working gas supplied to the second end of the spray gun main body 2a is heated by the heater 2c. The heating temperature of the working gas is appropriately set according to the composition of the film deposition raw material, and may be, for example, 100° C. or higher and 500° C. or lower. The working gas flows from the spray gun main body 2a to the nozzle 2b. As indicated by an arrow 32, a powder 10 is supplied from the powder feed unit 3 to the nozzle 2b via the pipe 5 as a film deposition raw material. The powder 10 may be, for example, aluminum powder.

The powder 10 supplied to the nozzle 2b is sprayed from a tip of the nozzle 2b toward the substrate 20 together with the working gas. The mask jig 1 is disposed to face the surface of the substrate 20. The sprayed powder 10 passes through the through hole la of the mask jig 1 to reach the surface of the substrate 20. A film is formed on the surface of substrate 20 with the sprayed powder 10 serving as the raw material.

### Powder Supply System

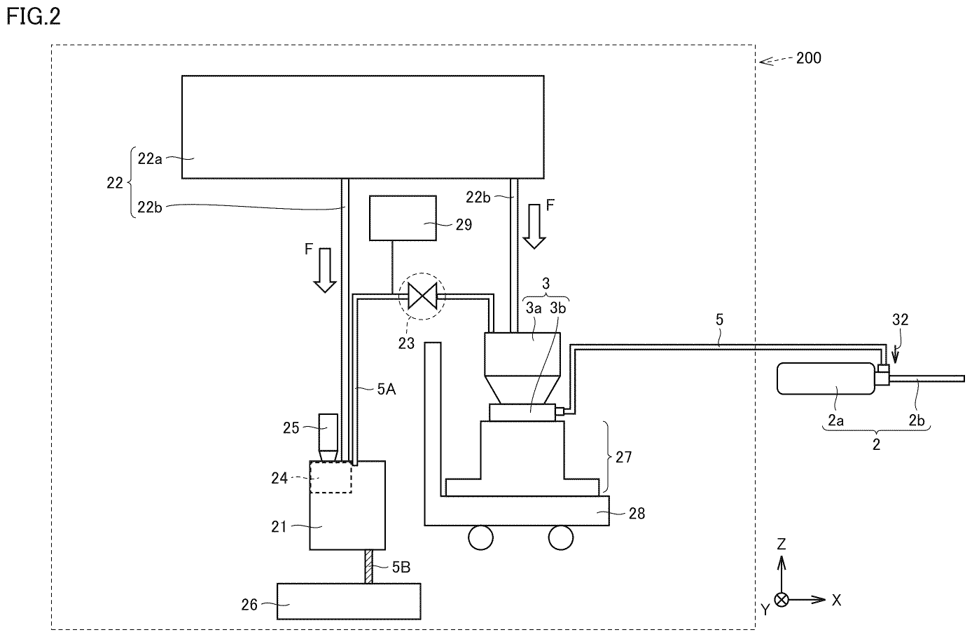

FIG. 2 is a schematic diagram illustrating the configuration of a powder supply system according to the present embodiment. For convenience of description, an X direction, a Y direction, and a Z direction orthogonal to each other are defined in FIG. 2. The X direction is defined as a left-right direction in FIG. 2, and the Y direction is defined as a depth direction of the paper in FIG. 2. The X direction and the Y direction are horizontal directions in FIG. 2. The Z direction is defined as an up-down direction, i.e., a vertical direction in FIG. 2. With reference to FIG. 2, a powder supply system 200 illustrated in FIG. 2 includes the powder feed unit 3 of FIG. 1. In other words, a region II that encloses the powder feed unit 3 with a dotted line in FIG. 1 is a part of the powder supply system 200 of FIG. 2. The powder supply system 200 corresponds to a region enclosed by a dotted line in FIG. 2. The powder supply system 200 includes a hopper 3a, a powder supply unit 21, a pressure adjustment unit 22, and an on-off valve 23.

The hopper 3a is a container which has a capacity of, for example, 12 liters and is configured to store the powder 10 (see FIG. 1: the same applies hereinafter). An inner wall surface of the hopper 3a may be inclined with respect to the Z direction. In other words, the cross-sectional area of a lower part of the hopper 3a perpendicular to the Z-direction is smaller than that of an upper part thereof in the Z-direction. As a result, the powder supplied into the hopper 3a can move downward smoothly.

The hopper 3a may include a powder storage unit 3b. The powder storage unit 3b is configured to output powder to the outside of the hopper 3a. The powder storage unit 3b is disposed below the hopper 3a in the Z direction. The powder storage unit 3b may be integrated with the hopper 3a (as a part of the same member), or may be a member different from the hopper 3a. Even if both are different members, the powder storage unit 3b is considered as a part of the hopper 3a (i.e., the powder storage unit 3b is included in the hopper 3a) in the present specification. In any of the abovementioned cases, the hopper 3a and the powder storage unit 3b together constitute the powder feed unit 3 of FIG. 1. The inner wall surface of the hopper 3a is continuous with the inner wall surface of the powder storage unit 3b. Therefore, the powder feed unit 3 as a whole forms a portion (a space enclosed by the inner wall surfaces) capable of storing powder. The powder feed unit 3 (the powder storage part 3b or the hopper 3a) is connected to the nozzle 2b of the spray gun 2 via the pipe 5. The powder feed unit 3, the pipe 5 and the spray gun 2 in FIG. 2 correspond to the powder feed unit 3, the pipe 5 and the spray gun 2 in FIG. 1.

The horizontal dimension of the powder storage unit 3b (in the X direction and the Y direction) is larger than the horizontal dimension of a lowermost portion in the vertical direction (the Z direction) of the hopper 3a excluding the powder storage unit 3b. In the powder feed unit 3 (the hopper 3a), since the plane area of the powder storage unit 3b is large, the powder in the hopper 3a can be stored in a wide space so as to smoothly flow toward the downstream side (toward the nozzle 2b).

The powder supply unit 21 is connected to the hopper 3a via, for example, a pipe 5A. In the powder supply system 200, the powder supply unit 21 is disposed on the upstream side of the powder feed unit 3 including the hopper 3a in the flow direction of powder.

The hopper 3a and the powder supply unit 21 are connected to the pressure adjustment unit 22. The pressure adjustment unit 22 is configured to adjust an internal pressure of the hopper 3a and an internal pressure of the powder supply unit 21 so as to maintain the internal pressure of the hopper 3a and the internal pressure of the powder supply unit 21 constant without changing over time, for example. The expression of “maintaining the pressure constant” in the present disclosure is not limited to a case where the pressure does not change strictly over time and remains exactly at the same value, and includes a case where the temporal change of the pressure is within ±10% of the average pressure. The same applies hereinafter.

The pressure adjustment unit 22 includes a pressure adjustment unit main body 22a (hereinafter referred to as “main body 22a”) and a pressurized pipe 22b. The main body 22a is configured to supply gas such as air (for example, to the hopper 3a). The pressurized pipe 22b may be provided as two pipes, i.e., a pipe that connects the main body 22a and the hopper 3a and a pipe that connects the main body 22a and the powder supply unit 21. In other words, the pressure adjustment unit 22 is a supply source that supplies gas into the hopper 3a and the powder supply unit 21.

The main body 22a connected to the hopper 3a and the main body 22a connected to the powder supply unit 21 may be integrated with each other (the same member), or may be separate from each other (different members). In other words, there may be one main body 22a connected to the hopper 3a and the other main body 22a connected to the powder supply unit 21, or there may be only one main body 22a.

As indicated by an arrow F in FIG. 2, gas is supplied (filled) from the main body 22a to the hopper 3a and to the powder supply unit 21 via the pressurized pipe 22b. The flow rate of the gas supplied from the main body 22a is adjusted constantly. Thus, the main body 22a controls the internal pressure of the hopper 3a and the internal pressure of the powder supply unit 21 constant without changing over time by using the gas, for example. The pressure adjustment unit 22 can adjust the internal pressure of the hopper 3a and the internal pressure of the powder supply unit 21 by adjusting the flow rate of the gas. Specifically, the pressure adjustment unit 22 can maintain the flow rate of the gas constant, and can increase or decrease the flow rate of the gas, for example. The internal pressure of the hopper 3a and the internal pressure of the powder supply unit 21 can be controlled constant without changing over time by maintaining the inflow rate of the gas equal to the outflow rate of the gas.

The on-off valve 23 is provided on the pipe 5A which is a member that connects the hopper 3a and the powder supply unit 21. The on-off valve 23 is switched between a state in which gas or the like can flow through the pipe 5A and a state in which gas or the like cannot flow therethrough. In other words, when the powder is supplied from the powder supply unit 21 to the hopper 3a, the on-off valve 23 is turned on (opened) so as to connect the powder supply unit 21 to the hopper 3a. This state is referred to as a first state. When the powder is refilled to the powder supply unit 21, the on-off valve 23 is turned off so as to disconnect the powder supply unit 21 from the hopper 3a. This state is referred to as a second state.

As described above, in the powder supply system 200, the powder supply unit 21, the pipe 5A (the on-off valve 23), the hopper 3a (the powder feed unit 3), the pipe 5, and the nozzle 2b (the spray gun 2) are arranged in this order from the upstream side to the downstream side of the flow of the powder into and out of the hopper 3a (the powder feed unit 3). In FIG. 2, the powder is supplied from the left side to the right side.

When the on-off valve 23 is turned on (opened), the powder supply unit 21 supplies the powder to the hopper 3a. This is performed by supplying the powder together with the gas from the powder supply unit 21 to the hopper 3a while maintaining a pressure difference between the hopper 3a and the powder supply unit 21 constant. The expression of “maintaining a pressure difference constant” in the present disclosure is not limited to a case where the pressure difference does not change strictly over time and remains exactly at the same value, and includes a case where the temporal change of the pressure difference is within ±10% of the average pressure of the hopper 3a. The same applies hereinafter.

When the on-off valve 23 is turned on (opened) (for example, in the first state in which the gas can flow through the pipe 5A), the internal pressure of the hopper 3a and the internal pressure of the powder supply unit 21 are maintained constant. Therefore, the pressure difference between the two internal pressures is constant. In the first state, the constant internal pressure of the powder supply unit 21 is greater than the constant internal pressure of the hopper 3a. Thus, the powder is supplied from the powder supply unit 21 into the hopper 3a via the pipe 5A.

On the other hand, when the on-off valve 23 is turned off (closed) (for example, in the second state in which the gas cannot flow through the pipe 5A), the pressure difference between the powder supply unit 21 and the hopper 3a is not required to be the same as the pressure difference therebetween in the first state.

The gas may be supplied into the powder supply unit 21 via one pressurized pipe 22b regardless of the state of the on-off valve 23. Also, the gas may be supplied into hopper 3a via the other pressurized pipe 22b. Due to the principle of thermal spraying, a negative pressure is generated in the nozzle 2b so that the pressure thereof is lower than that in the hopper 3a regardless of the state of the on-off valve 23. Due to this negative pressure, as indicated by an arrow 32, the gas and the powder in the hopper 3a is supplied to the nozzle 2b through the pipe 5. This gas functions as the working gas for the film deposition apparatus 100 (see FIG. 1). The negative pressure varies little over time regardless of the state of the on-off valve 23. Since the internal pressure of the hopper 3a is maintained constant, the pressure difference between the nozzle 2b and the hopper 3a is maintained substantially constant. In particular, the internal pressure of the hopper 3a is preferably greater than the atmospheric pressure. Thus, the gas and the powder can be smoothly supplied from the hopper 3a to the nozzle 2b by the negative pressure.

In addition, the powder supply system 200 may further include a powder refill unit 24. The powder refill unit 24 may be a jig for refilling powder into the powder supply unit 21.

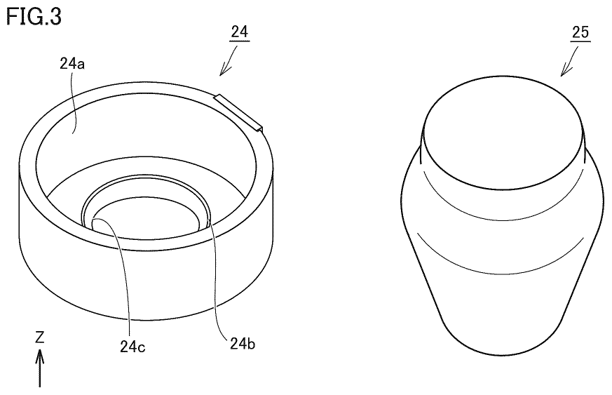

FIG. 3 is a schematic view illustrating a powder refill unit and a powder container. In FIG. 3, the vertical direction in the drawing is substantially the Z direction. However, FIG. 3 is a perspective view from slightly above FIG. 2. With reference to FIG. 3, the powder refill unit 24 is a cylindrical member for refilling powder into the powder supply unit 21. The powder refill unit 24 has, for example, a storage compartment (space) enclosed by an inner wall surface 24a and a bottom surface of the cylindrical powder refill unit 24. A bottom projection 24b is formed on the bottom surface of the powder refill unit 24. The bottom projection 24b extends upward in the Z direction from the bottom surface and has a hollow cylindrical shape.

The method of refilling powder to the powder supply unit 21 is as follows. A powder container 25, which is configured to store the powder to be refilled and an upper end thereof is attached with an aluminum film as a lid, is prepared. The powder container 25 is inserted into the storage compartment of the powder refill unit 24 in an inverted state, and is pushed downward in the storage compartment. After the aluminum film comes into contact with the bottom projection 24b, the powder container 25 is further pushed downward. As a result, the aluminum film is broken by the bottom projection 24b. Thus, the powder in the powder container 25 enters the powder refill unit 24. A part of the powder that has entered the powder refill unit 24 enters an opening 24c inside the bottom projection 24b and falls from the bottom projection 24b. For example, the powder refill unit 24 may be disposed at an upper position of the powder supply unit 21 (or on an upper surface of the powder supply unit 21) as illustrated in FIG. 2, and thereby, the powder may fall downward to refill the powder supply unit 21.

The powder supply system 200 further includes a vibration unit 26. In FIG. 2, the vibration unit 26 is disposed outside the powder supply unit 21. As illustrated in FIG. 2, the vibration unit 26 is connected to a bottom surface of the powder supply unit 21 via a connection member SB. However, the present disclosure is not limited thereto. For example, the vibration unit 26 may be connected to a portion of the powder supply unit 21 adjacent to the powder refill unit 24. The vibration unit 26 may be disposed outside the powder supply unit 21, or may be disposed inside the powder supply unit 21. The vibration unit 26 is configured to vibrate the powder supply unit 21. The vibration unit 26 may vibrate not only the main body of the powder supply unit 21 but also the powder refill unit 24.

The vibration unit 26 may be a generally known electronic vibration component. Due to the vibration of the vibration unit 26, for example, the powder introduced into the powder refill unit 24 falls smoothly into the powder supply unit 21, and is stored in the powder supply unit 21. If the vibration unit 26 is configured to vibrate the powder refill unit 24, the effect of shaking the powder introduced into the powder refill unit 24 to fall into the storage compartment of the powder supply unit 21 (the effect of refilling the powder into the powder supply unit 21) is enhanced.

As illustrated in FIG. 2, the hopper 3a (the powder feed unit 3) may be disposed on an electronic balance 27. The electronic balance 27 is configured to measure an amount of powder in the hopper 3a. The electronic balance 27 may be disposed on a carriage 28. Further, it is more preferable that the electronic balance 27 is configured to measure the amount of powder remained in the powder supply unit 21.

Although not illustrated in FIG. 2, the powder supply system 200 may include a pressure gauge configured to measure an internal pressure of the hopper 3a and an internal pressure of the powder supply unit 21.

It is more preferable that the powder supply system 200 includes a control system 29. The control system 29 automatically closes (turns off) the on-off valve 23 when the amount of powder remained in the powder supply unit 21 decreases and it is required to refill the powder into the powder supply unit 21 in the first state. At this time, the control system 29 controls the powder supply system 200 so as to minimize the change amount and the change time of the internal pressure of the hopper 3a. Specifically, for example, the amount of gas supplied from the pressure adjustment unit 22 to the hopper 3a is temporarily increased. In addition, the amount of gas supplied from the pressure adjustment unit 22 to the powder supply unit 21 is adjusted so that the internal pressure of the powder supply unit 21 becomes equal to the atmospheric pressure so as to open the powder supply unit 21 to the atmosphere.

### Prior Art and Effect Thereof

We will once again explain the prior art and problems to be solved by the prior art which lead to the conception of the present embodiment. For example, in a first stage of the prior art, the powder supply system does not include a powder supply unit 21, and includes a powder feed unit 3 which corresponds to the hopper 3a of FIG. 2 and a pressure adjustment unit 22. In this case, in order to maintain the internal pressure of the hopper 3a constant, a gas is supplied from the pressure adjustment unit 22 into the hopper 3a. From the viewpoint of stably supplying the working gas and the powder to the nozzle 2b by using a negative pressure, it is required to seal the hopper 3a and supply the gas into the hopper 3a at all times. However, in this case, only the hopper 3a can be supplied with powder from the outside. Therefore, it is required to open the hopper 3a to the atmospheric pressure at the time of supplying the powder. Thus, it is not possible to stably supply the powder from the hopper 3a to the nozzle 2b at this time. In other words, it is difficult to supply the powder to the nozzle 2b continuously and stably over time. For example, when the hopper 3a has a capacity of 12 liters, the continuous supply time of supplying powder to the nozzle 2b is approximately 8 hours. It is also required to further extend the continuous supply time.

Therefore, in a second stage of the prior art, the powder supply system includes a powder supply unit 21 in addition to the hopper 3a. The powder is supplied from the powder supply unit 21 to the hopper 3a. In the second stage, the continuous supply time is prolonged to about 24 hours, for example, as compared with that in the first stage. This is because the space where the powder can be stored is increased by the inclusion of the powder supply unit 21, and thereby the capacity of the entire powder supply system is expanded.

However, in the second stage, it is required to supply the gas to the powder supply unit 21 and the hopper 3a so as to make the internal pressure of the powder supply unit 21 greater than the internal pressure of the hopper 3a. Otherwise, the powder cannot be supplied from the powder supply unit 21 to the hopper 3a. In the second stage, the on-off valve 23 is not provided on the pipe 5A between the powder supply unit 21 and the hopper 3a. Therefore, the powder supply unit 21 and the hopper 3a are constantly connected to each other (corresponding to the first state). In this case, in order to refill powder into the powder supply unit 21, it is required to temporarily open the hopper 3a to the atmosphere. Therefore, similar to the first stage, it is not possible to stably supply the powder from the hopper 3a to the nozzle 2b. This may cause the state of the powder in the hopper 3a to vary between the upper side and the lower side, which may lead to variations in film thickness and film quality.

### Effect of the Present Embodiment

In order to solve the problems of the prior art as described above, the powder supply system 200 according to the present embodiment includes a hopper 3a, a powder supply unit 21, a pressure adjustment unit 22, and an on-off valve 23. The hopper 3a is configured to store the powder 10 to be supplied to the film deposition apparatus 100. The powder supply unit 21 is connected to the hopper 3a, and is configured to supply the powder 10 to the hopper 3a while maintaining a constant pressure difference with respect to the hopper 3a. The pressure adjustment unit 22 is configured to adjust the internal pressure of the hopper 3a and the internal pressure of the powder supply unit 21 so as to maintain the internal pressure of the hopper 3a and the internal pressure of the powder supply unit 21 constant. The on-off valve 23 is provided on a member that connects the hopper 3a and the powder supply unit 21.

In addition to the hopper 3a, the powder supply system further includes a powder supply unit 21 and an on-off valve 23 provided on a member that connects the hopper 3a and the powder supply unit 21. Therefore, at the time of supplying the powder 10, the internal pressure of the hopper 3a can be maintained substantially constant simply by switching the on-off valve 23 to the second state. The influence of a negative pressure on the supply of the powder 10 from the hopper 3a to the nozzle 2b can be minimized, and thereby the fluctuation of a pressure difference between the hopper 3a and the nozzle 2b can be minimized. In other words, while a substantially constant amount of the powder 10 is being supplied to the nozzle 2b, the powder supply unit 21 can be opened to the atmosphere so as to refill the powder 10. Therefore, the powder 10 can be supplied to the nozzle 2b continuously and stably over time. In other words, the powder 10 can be supplied continuously and stably over time in a stable quantity and quality with minimal error.

The pressure adjustment unit 22 is configured to apply a constant pressure higher than the internal pressure of the hopper 3a to the powder supply unit 21. Therefore, the flow rate of the powder in the pipe 5A can be maintained constant by utilizing the constant pressure difference between the hopper and the powder supply unit. Therefore, the powder can be supplied continuously and stably over time.

In the powder supply system 200 described above, when the powder 10 is supplied from the powder supply unit 21 to the hopper 3a, the on-off valve 23 is switched to the first state in which the on-off valve is turned on so as to connect the powder supply unit 21 to the hopper 3a. When the powder 10 is refilled to the powder supply unit 21, the on-off valve 23 is switched to the second state in which the on-off valve is turned off so as to disconnect the powder supply unit 21 from the hopper 3a. Thus, in the first state, the powder 10 can be supplied from the powder supply unit 21 to the hopper 3a continuously and stably over time by utilizing the constant pressure difference. In the second state, the powder 10 can be supplied from the hopper 3a to the nozzle 2b continuously and stably over time while the powder supply unit 21 is being opened to the atmosphere. In other words, regardless of the state of the on-off valve 23, the powder 10 can be supplied from the hopper 3a to the nozzle 2b continuously and stably over time.

In the powder supply system 200, the internal pressure of the hopper 3a is maintained constant before and after the switching between the first state and the second state. Specifically, the internal pressure of the hopper 3a is maintained constant between the first state and the second state. However, as described above, a constant pressure includes a case where the temporal change of the pressure is within ±10% of the average pressure. In addition, the internal pressure of the hopper 3a can be maintained substantially constant at the time of switching from the first state to the second state and at the time of switching from the second state to the first state. As to be described later, although the internal pressure of the hopper 3a may change slightly for a very short time, it is also possible to control the internal pressure so that it does not change at all. Thus, the powder 10 can be supplied from the hopper 3a to the nozzle 2b continuously and stably over time regardless of the state of the on-off valve 23.

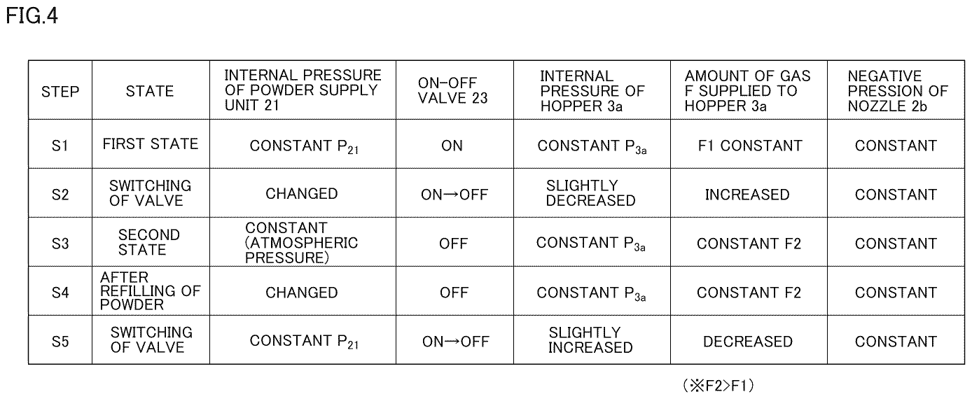

The effects mentioned above will be summarized with reference to FIG. 4. FIG. 4 is a table listing a series of steps for supplying powder and refilling powder in the powder supply system according to the present embodiment, and states of respective constituent members.

With reference to FIG. 4, in the first state (S1), the internal pressure of powder supply unit 21 is maintained at a constant value (for example, P₂₁). The on-off valve 23 is turned on (opened). The internal pressure of the hopper 3a is maintained at a constant value (for example, P₃ₐ). The amount of gas F (see FIG. 2) supplied from the pressure adjustment unit 22 to the hopper 3a is maintained at a constant value (for example, F1). The negative pressure of the nozzle 2b is maintained constant. Since the internal pressure of the hopper 3a and the negative pressure of the nozzle 2b are constant, the pressure difference therebetween is constant, and thereby the powder 10 can be supplied to the nozzle 2b continuously and stably.

When the amount of powder in the powder supply unit 21 decreases, the on-off valve 23 is switched from the first state to the second state so as to fill the powder 10 into the powder supply unit 21 (step S2). In step (S2), the powder supply unit 21 is opened to the atmosphere. Thus, the internal pressure of the powder supply unit 21 is changed. Specifically, the gas supplied into the powder supply unit 21 is discharged. The on-off valve 23 is switched from the on (opened) state to the off (closed) state. The internal pressure of the hopper 3a may become slightly smaller than P₃ₐ. This is because the supply of the gas from the powder supply unit 21 is stopped by turning off the on-off valve 23. Accordingly, the amount of gas F supplied from the pressure adjustment unit 22 to the hopper 3a is increased. On the other hand, the negative pressure of the nozzle 2b is maintained substantially constant in step S2.

The powder 10 is refilled into the powder supply unit 21 in the second state (S3). In the second state (S3), the internal pressure of the powder supply unit 21 is maintained at a constant value (atmospheric pressure). The on-off valve 23 is turned off (closed). The internal pressure of the hopper 3a is maintained at a constant value (for example, P₃ₐ). The amount of gas F (see FIG. 2) supplied from the pressure adjustment unit 22 to the hopper 3a is maintained at a constant value (for example, F2). F2 is greater than F1. This is to compensate for the stopped gas supply from the powder supply unit 21 so as to maintain the internal pressure of hopper 3a at the same level as that in the first state. The negative pressure of the nozzle 2b is maintained constant. Accordingly, the pressure difference between the internal pressure of the hopper 3a and the negative pressure of the nozzle 2b is the same as that in the first state (S1). Therefore, the powder can be supplied to the nozzle 2b in the same manner as in the first state (S1).

After the refill of powder (S4), i.e., after the refill of the powder 10 to the powder supply unit 21 is completed, the following occurs until the refill of the powder 10 to the hopper 3a is restarted. The internal pressure of the powder supply unit 21 is changed. In other words, the internal pressure of the powder supply unit 21 is changed. This is because a large amount of gas is supplied into the powder supply unit 21 so as to return the pressure to the constant value P₂₁ in the first state. The on-off valve 23 remains closed at this time. The internal pressure of the hopper 3a is maintained at a constant value (for example, P₃ₐ). The amount of gas F (see FIG. 2) supplied from the pressure adjustment unit 22 to the hopper 3a is maintained at a constant value (for example, F2). The negative pressure of the nozzle 2b is maintained constant.

After the supply of a large amount of gas to the powder supply unit 21 is completed after the refill of powder and the internal pressure of the powder supply unit 21 has been substantially returned to P₂₁, the on-off valve 23 is switched to the first state again (step S5). At this time, when the on-off valve 23 is opened to allow the gas to flow into the pipe 5A, the internal pressure of the powder supply unit 21 may be changed momentarily. However, the internal pressure of the powder supply unit will be immediately returned to the constant value P₂₁. Since the returned internal pressure is substantially constant, the internal pressure of the powder supply unit 21 is described as “constant P₂₁” in FIG. 4. The on-off valve 23 is switched from the off (closed) state to the on (opened) state. The internal pressure of the hopper 3a may be slightly increased from P₃ₐ. This is because the inflow of gas from the powder supply unit 21 to the hopper 3a is restarted due to the connection of the on-off valve 23. Accordingly, the amount of gas F supplied from the pressure adjustment unit 22 to the hopper 3a is decreased. On the other hand, the negative pressure of the nozzle 2b is maintained substantially constant in step S2. The negative pressure of the nozzle 2b is always maintained constant at the time of switching the on-off valve 23 as well as in the first state and the second state. This has been described above.

As described above, the internal pressure of the hopper 3a may be slightly changed, in other words, may be slightly increased or decreased from the constant value P₃ₐ during the step of switching the on-off valve (S2, S5). However, as long as the pressure is changed within a time as short as possible, the internal pressure of the hopper 3a can be maintained substantially constant throughout the entire process.

In addition, in the step (S2), the control system 29 may be operated so as to decrease the amount of gas supplied to the hopper 3a, and meanwhile increase the amount of gas supplied from the pressure adjustment unit 22 to the hopper 3a by the same amount as the decreased amount. In this way, even during the step (S2), the internal pressure of the hopper 3a may not be changed at all, and thereby the powder 10 can be supplied to the nozzle 2b more stably. Similarly, during the step (SS), the control system 29 may be operated so as to increase the amount of gas supplied to the hopper 3a, and meanwhile decrease the amount of gas supplied from the pressure adjustment unit 22 to the hopper 3a by the same amount as the increased amount. This further improves the performance of the powder supply system 200. As a result, the internal pressure of the hopper 3a can be maintained constant throughout the entire process.

It should be understood that the embodiments disclosed herein are illustrative and non-restrictive in all respects. Unless otherwise contradicted, at least two features described in the presently disclosed embodiment may be combined.

Hereinafter, the present disclosure will be summarized as the following aspects.

### (Aspect 1)

A powder supply system comprising:
a hopper that stores powder to be supplied to a film deposition apparatus;
a powder supply unit that is connected to the hopper and supplies the powder to the hopper while maintaining a constant pressure difference with respect to the hopper;
a pressure adjustment unit that adjusts an internal pressure of the hopper and an internal pressure of the powder supply unit so as to maintain the internal pressure of the hopper and the internal pressure of the powder supply unit constant; and
an on-off valve that is provided on a member that connects the hopper and the powder supply unit.

### (Aspect 2)

The powder supply system according to aspect 1, wherein
when the powder is supplied from the powder supply unit to the hopper, the on-off valve is switched to a first state in which the on-off valve is turned on so as to connect the powder supply unit to the hopper, and
when the powder is refilled to the powder supply unit, the on-off valve is switched to a second state in which the on-off valve is turned off so as to disconnect the powder supply unit from the hopper.

### (Aspect 3)

The powder supply system according to aspect 2, wherein
the internal pressure of the hopper remains constant before and after the on-off valve is switched between the first state and the second state.

### (Aspect 4)

The powder supply system according to any of aspect 1 to aspect 3, wherein
the pressure adjustment unit controls the internal pressure of the hopper and the internal pressure of the powder supply unit by flowing gas into the hopper and the powder supply unit.

### (Aspect 5)

The powder supply system according to any of aspect 1 to aspect 4, further comprising:
a powder refill unit that refills the powder to the powder supply unit.

### (Aspect 6)

The powder supply system according to aspect 5, further comprising:
a vibration unit that vibrates the powder supply unit.

### (Aspect 7)

The powder supply system any of aspect 1 to aspect 6, wherein
the hopper includes a powder storage unit that outputs the powder, and
the horizontal dimension of the powder storage unit is larger than the horizontal dimension of a lowermost portion in the vertical direction of the hopper excluding the powder storage unit.

### REFERENCE SIGNS LIST

1: mask jig; 2: spray gun; 2a: spray gun main body; 2b: nozzle; 2c: heater; 3: powder feed unit; 3a: hopper; 3b: powder storage unit; 4: gas supply unit; 5, 5A, 6: pipe; 5B: connection member; 7: valve; 8: pressure sensor, 9: temperature sensor; 10: powder; 20: substrate; 21: powder supply unit; 22: pressure adjustment unit; 22a: pressure adjustment unit main body; 22b: pressurized pipe; 23: on-off valve; 24: powder refill unit; 24a: inner wall surface; 24b: bottom projection, 24c. opening; 25: powder container; 26: vibration unit; 27: electronic balance; 28: carriage; 29: control system; 30, 31, 32: arrow; 100: film deposition apparatus; 200: powder supply system.

1. A powder supply system comprising:
a hopper that stores powder to be supplied to a film deposition apparatus;
a powder supply unit that is connected to the hopper and supplies the powder to the hopper while maintaining a constant pressure difference with respect to the hopper;
a pressure adjustment unit that adjusts an internal pressure of the hopper and an internal pressure of the powder supply unit so as to maintain the internal pressure of the hopper and the internal pressure of the powder supply unit constant; and
an on-off valve that is provided on a member that connects the hopper and the powder supply unit.

2. The powder supply system according to claim 1, wherein
when the powder is supplied from the powder supply unit to the hopper, the on-off valve is switched to a first state in which the on-off valve is turned on so as to connect the powder supply unit to the hopper, and
when the powder is refilled to the powder supply unit, the on-off valve is switched to a second state in which the on-off valve is turned off so as to disconnect the powder supply unit from the hopper.

3. The powder supply system according to claim 2, wherein
the internal pressure of the hopper remains constant before and after the on-off valve is switched between the first state and the second state.

4. The powder supply system according to claim 1, wherein
the pressure adjustment unit controls the internal pressure of the hopper and the internal pressure of the powder supply unit by flowing gas into the hopper and the powder supply unit.

5. The powder supply system according to claim 1, further comprising:
a powder refill unit that refills the powder to the powder supply unit.

6. The powder supply system according to claim 5, further comprising:
a vibration unit that vibrates the powder supply unit.

7. The powder supply system according to claim 1, wherein
the hopper includes a powder storage unit that outputs the powder, and
the horizontal dimension of the powder storage unit is larger than the horizontal dimension of a lowermost portion in the vertical direction of the hopper excluding the powder storage unit.
